(19) United States
(12) Patent Application Publication
(10) Pub. No.: US 2009/0172517 A1
(43) Pub. Date: Jul. 2, 2009

(54) Document parsing method and system using web-based GUI software

(76) Inventor: Bhagavathi P. Kalicharan, Herndon, VA (US)

Correspondence Address: LOUIS VENTRE, JR, 2483 OAKTON HILLS DRIVE, OAKTON, VA, 22124-1530, US

(21) Appl. No.: 11/965,040

(22) Filed: Dec. 27, 2007

(51) Int. Cl. G06F 17/30

(52) U.S. Cl. 715/234

(57) ABSTRACT

A computer implemented method and system operational via the Internet to parse a document and extract textual information. The method includes steps of presenting to the user a graphical user interface; receiving from a user an electronic document; enabling the user to specify rules computer implementable to extract textual information; implementing the rules; storing the extracted textual information; accepting payment from the user; and delivering the extracted textual information. The system includes a server accessible via the Internet using a web browser and software. The software is accessible through the web browser. The software presents to the user a graphical user interface to interact with the server to receive an electronic document in text format, create rules implementable to extract textual information, implement the rules, accept payment, and, deliver the extracted textual information. The software is operable to store the extracted textual information.

### FIELD OF INVENTION

In the field of data processing, a method and system for parsing text documents using a graphical user interface over the Internet.

### BACKGROUND OF THE INVENTION

The invention is directed at a method and system for extracting textual information from any electronic document in text format using software and a service provided over the Internet. The invention enables a user with little or no programming experience to extract desired text, numbers or values from any textual document by accessing the system over internet using a simple web browser. Validation logic can also be applied on the extracted text data. If a user has a hard copy document, the method and system assumes that the user first creates a document of textual information and then utilizes the invention. Textual information is information, such as alphanumeric characters stored in a text form, such as, for example, ASCII format.

Businesses that convert hard copy documents to text will often use a single program for such conversion. Such conversion programs or utilities are called as OCR (Optical Character Recognition) engines. If multiple hard copy documents have the same format but with different text entries, then each text document converted from the hard copy contains words that have the same relational position. Having a standard text document wherein the words have the same relational position enables a very efficient Internet-based method and system for extracting specific textual information from within that document with no programming requirements. The extraction logic can be scheduled to repetitively process on one or multiple text documents.

### DESCRIPTION OF PRIOR ART

Prior art involving information extraction from a hard copy document typically involves scanning a document. The present invention permits one to use a scanner but does not include or require the use of a scanner. Prior art also typically involves either creating a special program for extracting that information by a software developer, or applying a search mechanism to find and then extract the information. A software developer, also known as an application developer, would typically create a specific program to accomplish a task, such as text extraction that is operated on the user's computer. An example of prior art employing a scanner and a user's computer to implement a text extraction program on the user's computer is U.S. Pat. No. 6,683,697.

The present invention eliminates the need for an application developer and the expertise needed to write a dedicated text extraction program operated on the user's computer. It eliminates costs for multiple licenses for text extraction programs on multiple computers. It greatly simplifies the task of parsing a text document and extracting only the textual information sought by operating a user-friendly graphical user interface. It eliminates any programming experience requirement. All a user needs to use the invention is an Internet connection and a text document and the ability to respond to questions posed in a graphical user interface. This invention also enables reuse of extraction logic by duplicating it and making appropriate changes rather having to start from the scratch. This invention also enables implementation of validation logic to the extracted data using a graphical interface over Internet.

The invention eliminates the difficulties in running a custom extraction program and the expense of maintaining and operating it. It eliminates the infrastructure needed for a user to own and run the software program. The invention provides the software means for extracting textual information that is operated via a graphical user interface accessed by a user with an Internet web browser. It centralizes the text extraction system at a single, Internet-accessible location, which may be important for large businesses with perhaps hundreds of computers otherwise involved in parsing a document. The centralized system permits greater efficiency gained by storing text extraction rules for re-use by any authorized person.

The prior art also discloses inventions that extract information from a document and produce an output based on a service definition provided by the form publisher. A recent example of this is U.S. Patent Application 20010054046 for an automatic forms handling application service provided on a global computer network, such as the Internet. Prior art of this kind requires completion of a standard form, submission of that form to a forms handling system. The form includes one or more data submission fields for accumulating data entries submitted into the form by visitors to the forms handling system.

The present invention is different in that it applies to any text document, not a preformatted form with data entry fields. It is much more broadly applicable to text documents and not those where a form field has textual data entries. The present invention is further distinguished in that it parses the text document to extract text based on rules entered by the user through a web-based graphical user interface.

Prior art also teaches converting paper documents to electronic documents and managing the electronic documents. A recent example of such prior art for converting paper documents is U.S. Patent Application 20060036587, which is for a method and system for storing, organizing and providing remote electronic access to documents. A cover sheet including a standard set of identification data characterizing each document is developed and stored. A digital version of each document is created and stored by scanning each contract. This type of prior art is distinguished from the present invention in that it does not employ a graphical user interface accessed over the Internet with a web browser, and more importantly, use such Internet-accessible graphical user interface to create rules to extract textual information from a text document. Further distinction from the prior art lies in the options to add custom validation logic to the extracted textual data.

Accordingly, the present invention will serve to improve the state of the art by creating a simple process for parsing a text document and extracting desired information. The present invention eliminates the need for a custom program or utility, the expertise needed to write the program or utility (a software developer) and the dedicated text extraction program operated on the user's computer. By using a software-based graphical user interface and Internet-accessible system, the present invention reduces the cost involved in running a program or utility or in obtaining multiple licenses for specific text extraction application programs. The present invention permits greater efficiency gained by centrally storing text extraction rules for re-use by any authorized person.

### BRIEF SUMMARY OF THE INVENTION

A computer implemented method and system operational via the Internet to parse a document and extract textual information. The method includes steps of presenting to the user a graphical user interface to interact with a server over the Internet using a web browser; receiving from a user an electronic document in text format; enabling the user to specify rules computer implementable to extract textual information from the electronic document; implementing the rules to extract the textual information; storing the extracted textual information in an electronic format; accepting payment from the user for delivery of extracted textual information; and delivering the extracted textual information to the user.

The system includes a server accessible via the Internet using a web browser and software. The software is accessible by a user connecting with the server over the Internet through the web browser. The software is operable to present to the user a graphical user interface to interact with the server to receive from a user an electronic document in text format, create rules implementable to extract textual information from the electronic document, implement the rules to extract the textual information, accept payment from the user for delivery of extracted textual information, and, deliver the extracted textual information to the user. The software is further operable to store the extracted textual information in an electronic format.

### BRIEF DESCRIPTION OF THE DRAWINGS

Referring now to the drawings which represent preferred embodiments of the method and system of the invention:

FIG. 1 is a flow diagram of a method of the invention and alternative steps of this method.

FIG. 2 is a diagram of system components of the invention.

FIG. 3 is a diagram of additional system software component limitations.

### DETAILED DESCRIPTION

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural and operational changes to the order of steps in the method may be made without departing from the scope of the present invention. References herein to the method and the system are intended to refer to the preferred embodiments and preferred alternatives shown in the figures.

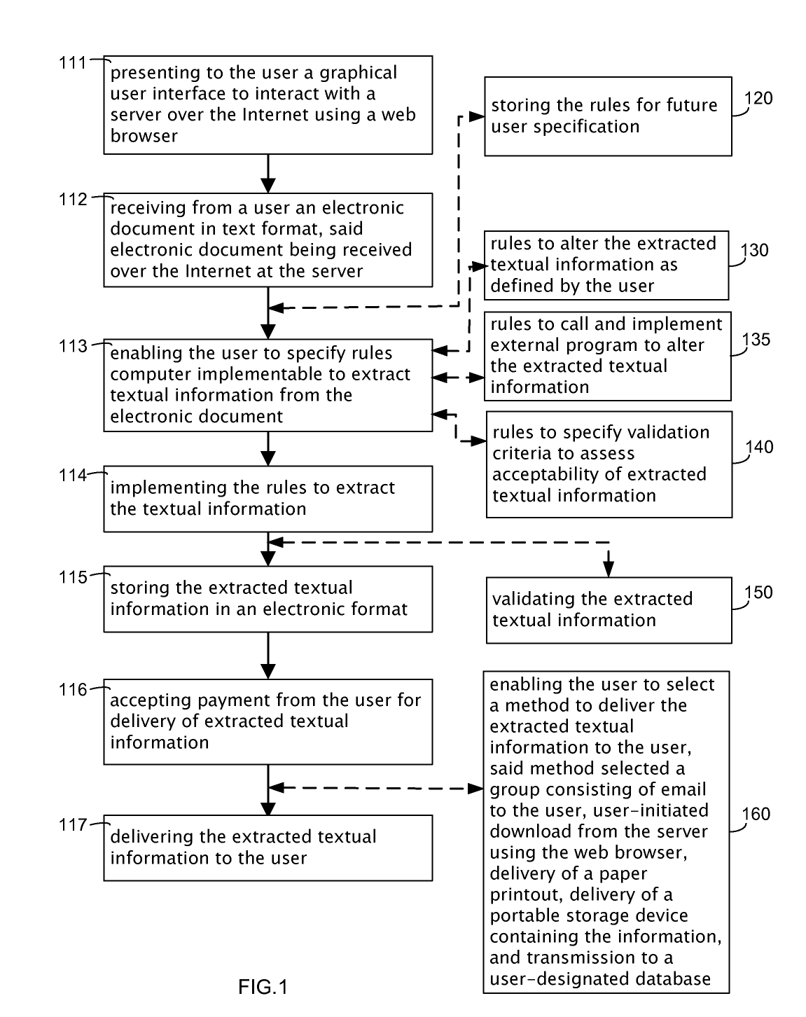

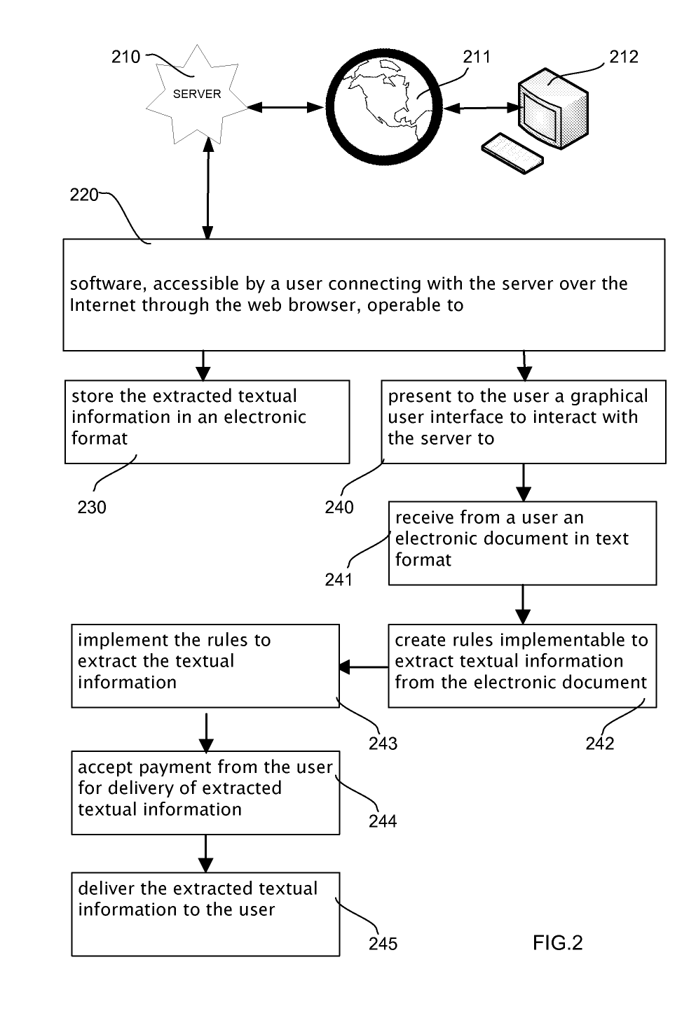

FIG. 1 is a flow diagram of a preferred embodiment of method of the invention and preferred alternative steps illustrated with dashed lines. The method relates to a provider of a service and is best understood in conjunction with FIG. 2, the diagram showing a preferred embodiment of the system.

The method includes a first step (111) of presenting to the user (212) a graphical user interface (GUI) to interact with a server (210) over the Internet (211) using a web browser. A user (212) is typically a person employing a computer with the web browser installed thereon. A user (212) is intended to be broadly defined and may also include a program operated by a person to automate the user's interaction with the server (210). The user's interaction may be by other devices, such as telephones, that are well known in the art to be able to communicate over the Internet (211) using a web browser. The user (212) would access the server (210) with the web browser and such access would present a GUI at the user's computer through the web browser.

The method includes a second step (112) of receiving from a user (212) an electronic document in text format. The electronic document is received over the Internet (211) at the server (210). The electronic document is in text format when sent by the user (212) and received by the server (210), which is a common document format. Conversion of a hard copy document to text format would be the responsibility of the user (212) and is not a part of the invention. Receipt at the server (210) would be incident to the user (212) uploading an electronic document. A graphical user interface accessed by the browser would enable the user (212) to identify the file on the user's computer and command the server (210) to upload the electronic document.

The method includes a third step (113) of enabling the user (212) to specify rules computer implementable to extract textual information from the electronic document. Enabling the user (212) typically means that software (220) installed on the server (210) presents a graphical user interface to the user (212) in which the rules for extracting the textual information from the electronic document would be searched for and modified or reused as is, or formulated from scratch. For example, the graphical user interface would enable the user (212) to search for an existing rule that matched the electronic document in text format uploaded by the user in step (112). If such an existing rule existed, finding it would allow the user to apply the existing rule, or duplicate it for modification to create a new rule based on the match. As a second example illustrating formulating a rule from scratch, the graphical user interface would enable the user (212) to specify rules where the target text is located in reference to another word, or by the number of the sentence, or by the number of words from the beginning, or by the number of letters or numbers in relation to another word, etc.

An alternative embodiment adds a step (120) of storing the rules for future user (212) specification. Once rules for a particular electronic document are created, these rules are saved in the system for later use by the user when a similar document is received at the server (210). Such storage would enable a user (212) to search and retrieve a stored rule, edit as appropriate and apply that to a similar electronic document.

An alternative embodiment adds an additional text alteration function (130) to the third step (113) of enabling the user (212) to specify rules computer implementable to extract textual information from the electronic document. The additional text alteration function (130) allows the user (212) to specify rules that are further computer implementable to alter the extracted textual information as defined by the user (212). For example, such alteration may involve an arithmetic or algebraic manipulation, or a conversion of text to numbers or monetary values.

An alternative embodiment adds an external program function (135) to the third step (113) of enabling the user (212) to specify rules computer implementable to extract textual information from the electronic document. The external program function (135) allows the user (212) to specify rules that are further computer implementable to call and implement an external program to alter extracted textual information from the text document. This external program function (135) allows a user to apply custom programs or routines, which are uploaded to the server (210) or are accessed via the Internet.

The method includes a fourth step (114) of implementing the rules to extract the textual information. This step is typically implemented using software (220) installed on the server (210) after the user (212) selects or specifies rules for extraction of the textual information.

An alternative embodiment adds a validation step (140) of enabling the user (212) to specify validation criteria to assess the acceptability of the extracted textual information and to understand runtime errors. Typical user-specified criteria, such as number of characters in the extracted text, are added by the user (212) through the graphical user interface. An example relating to runtime errors is when the software applies required validations to the data elements and categorizes the message to be fatal, error, warning, information or debug.

Consistent with this alternative embodiment allowing a user (212) to specify validation criteria, this embodiment would also add a validating step (150) for validating the extracted textual information. This function would be performed by the software (220) operated by the server (210), which would report success or failure and other information sufficient to allow the user (212) to revise the rules to appropriately extract the desired textual information.

The method includes a fifth step (115) of storing the extracted textual information in an electronic format. Once the textual information is extracted that information is converted to a new or existing electronic format, typically on the server (210). Thus, storing the extracted textual information in an electronic format might include storage in a relational format in a database software depending on the delivery type chosen by the user. For example, extracted data may be stored in the local database on the server (210) and be used for data mining or analysis purposes, effectively converting an existing electronic data file into a larger data file. Data is then extracted from the local database to deliver the output in the user chosen delivery format. The existing electronic data file may be a data base file that separates and adds the information to a particular spreadsheet format, effectively converting an existing electronic data file into a larger data file. This file may also be sent to storage in some other computer connected to the server (210).

The method includes a sixth step (116) of accepting payment from the user (212) for delivery of extracted textual information. This step includes allowing a user (212) to pay for extracted textual information either for a single transaction or as part of a continuing use of the system with payment from an established account or system created for that user (212).

The method includes a seventh step (117) of delivering the extracted textual information to the user (212). Delivery of the extracted textual information would typically involve the transfer of the electronic file containing the information. All manner of delivery is possible using the system. The extracted textual information may be delivered in any format sought by the user. Examples of such formats are extensible Markup Language (XML), Structured Query Language (SQL) statements for populating any database systems, character delimited files, MICROSOFT ACCESS, MICROSOFT EXCEL, and seamless integration with any remote custom application systems or providing accessibility through remote web service invocation, such as a software system designed to support interoperable Machine to Machine interaction over a network using SOAP (Simple Object Access Protocol) standard.

An alternative embodiment includes a delivery selection step (160) of enabling the user (212) to select a method to deliver the extracted textual information to the user (212). Examples of typical methods that may be selected by the user (212) include email to the user, user-initiated download from the server (210) using the web browser, delivery of a paper printout, delivery of compact disk, DVD or other portable storage device containing the information, or electronic transmission to a user-designated database.

FIG. 2 diagrams a preferred embodiment of the system components of the invention. This embodiment comprises a system for parsing a document that includes two primary components: a server (210) accessible via the Internet (211) using a web browser; and, software (220), accessible by a user (212) connecting with the server (210) over the Internet (211) through the web browser.

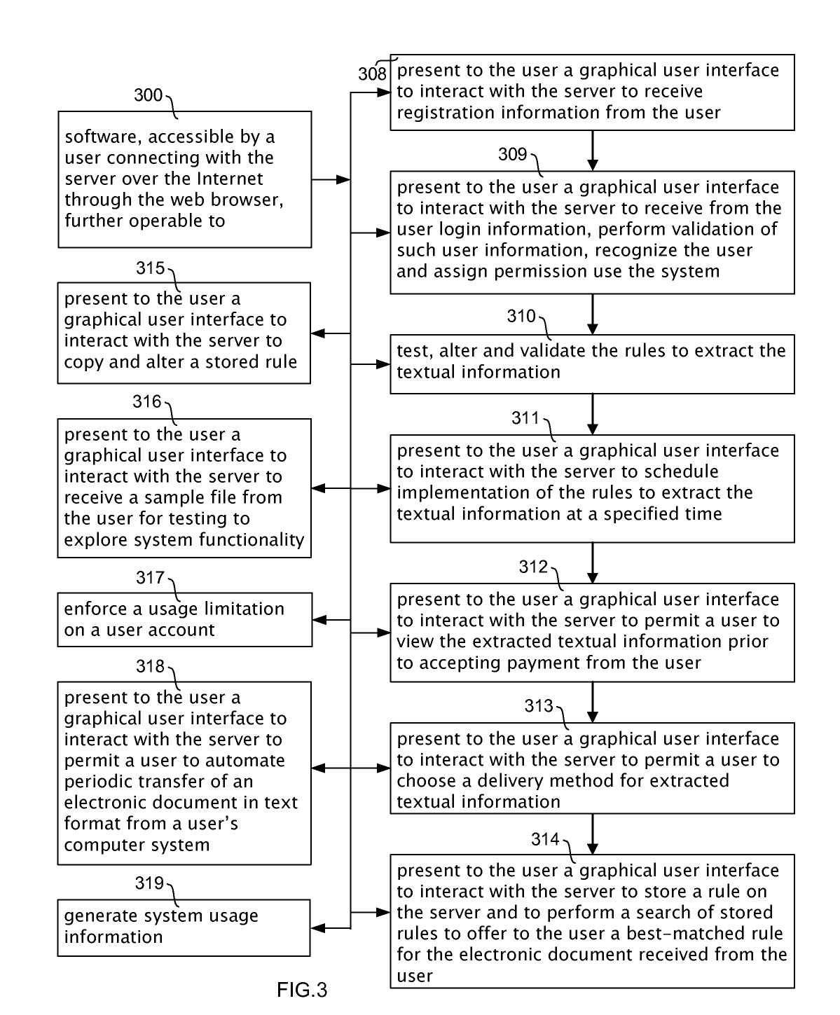

FIG. 3 diagrams alternative embodiments of the system with additional software (220) capabilities that are disclosed herein in the context of the preferred embodiment of FIG. 2. FIG. 3, thus, diagrams additional capabilities for “software, accessible by a user connecting with the server over the Internet through the web browser, further operable to” (300) perform the functions listed on FIG. 3 and discussed below.

Servers, also known as computer servers, accessible via the Internet (211) are well known in the art. The software (220) has two functional abilities: The first functional ability (230) is that the software must be operable to store the extracted textual information in an electronic format. The second functional ability (240) is that it must be operable to present to the user (212) a graphical user interface to interact with the server (240). Concerning the second functional ability (240), there are five GUI capabilities in user (212) interaction with the software stored in the server (210).

The first GUI capability (241) is to receive from a user (212) an electronic document in text format. The user's browser accesses the server over the Internet (211) and is presented with a page that asks the user (212) to specify the electronic document in text format to be uploaded.

An alternative embodiment adds a GUI registration capability (308) to present to the user (212) a graphical user interface to interact with the server (210) to receive registration information from the user (212). User (212) registration provides a means to identify the user (212), assign a username and password, log the preferences of the user (212), for example for delivery of extracted textual information, and to arrange for payment information to be entered by the user (212).

An alternative embodiment adds a GUI sample capability (316) to receive a sample rule or file from the user (212) for testing to explore system functionality. This capability offers a user (212) the means to test drive the system and the service it provides to see if it matches the user's needs. For maximum user (212) satisfaction, this sample testing capability would typically permit a user (212) to engage all system activities except those involving the actual delivery of the electronic file.

An alternative embodiment adds a GUI login capability (309) to receive from the user (212) login information, perform validation of such user (212) information, recognize the user (212) and assign permission use the system. While the system may be accessed and used without user (212) registration or login, these functions permit a user to process payment and enables processing a text document and delivery of extracted textual information to the user (212).

An alternative embodiment adds a GUI usage capability (317) to enforce a usage limitation on a user (212) account. This capability or option enables a user (212) to specify in advance how much system usage the user (212) is willing to pay for, thus preventing use of the system that would exceed a user's budget. It would also enable a system manager to prevent excessive use of the system by users who elect not to pay for the service to receive delivery of an electronic file. For example, Account Level 1 would be allowed to perform x number of extractions in a day where as the Account Level 2 is allowed x+y extractions.

An alternative embodiment adds a GUI upload-scheduling capability (318) to permit a user (212) to automate periodic transfer of an electronic document in text format from a user's computer system to the server (210) and perform extraction of textual information without additional user input. A regular user (212) of the subject invention may want to automate the upload of electronic documents at periodic intervals and this capability allows the user (212) to enter the upload-schedule to the server (210). For example, the periodic intervals might be hourly, daily, weekly, monthly, yearly or one-time execution on a specific date and time chosen by the user.

The second GUI capability (242) is to create rules implementable to extract textual information from the electronic document. The software (220) operable rules created with the GUI would identify where to find the text sought to be extracted, such that text or data extraction is by pattern-based and parameter rules.

An alternative embodiment adds a software (220) storage and search capability (314) to store a rule on the server (210) and to present to the user (212) a GUI search capability to perform a search of stored rules to offer to the user (212) a best-matched rule for the electronic document received from the user (212). This capability or option enables the user (212) to speed through the rules creation step by finding and utilizing previously created rules.

An alternative embodiment adds a GUI rule-alteration capability (315) to copy and alter a stored rule. This capability or option allows a user (212) to copy existing rules and then alter them. It is a capability that is dependent upon the ability to store and search for rules, that is, to the storage and search capability (314).

An alternative embodiment adds a rule-testing capability (310) to test, alter and validate the rules to extract the textual information. A user (212) can run the rules on an electronic document to see the results of the rules created, that is, to see the extracted textual information or any information obtained from the extracted textual information. If the rules work for the test document as intended, the user (212) can then apply the rules to that document and others that maybe uploaded. If the rules do not work as intended, then the user (212) can immediately alter the rules and validate the revised rules for use on the electronic document, or create a brand new set of rules.

The third GUI capability (243) is to implement the rules to extract the textual information. These rules target the location of the particular textual information found in the electronic document in text format that has been uploaded. The rules implemented by the software (220) would locate the textual information sought to be extracted from the electronic document.

An alternative embodiment adds a GUI scheduling capability (311) to present to the user (212) a graphical user interface to interact with the server (210) to schedule implementation of the rules to extract the textual information at a specified time. This offers the user (212) the convenience of setting up the system for later use. For example, the specified time options might be for intervals such as hourly, daily, weekly, monthly, yearly or one-time execution on a specific date and time chosen by the user.

The fourth GUI capability (244) is to accept payment from the user (212) for delivery of extracted textual information. Typically, payment would be made once the extracted textual information is available for downloading or other delivery to the user (212).

An alternative embodiment adds a GUI viewing capability (312) to permit a user (212) to view the extracted textual information prior to accepting payment from the user (212). This option permits a user (212) to examine the extracted information before making a decision to pay for services rendered by the system in automating the extraction of textual information.

The fifth GUI capability (245) is to deliver the extracted textual information to the user (212). Typically, after payment, the software (220) would permit immediate electronic delivery of the extracted textual information to the user (212).

An alternative embodiment adds a GUI viewing capability (313) to permit a user (212) to choose a delivery method for extracted textual information. This option adds convenience for the user (212). While the user (212) may have registered a preferred delivery method, the user (212) may prefer a different delivery method for a particular run of the software (220) and this option allows the user (212) to make a selection for the delivery consistent with available payment/pricing options.

An alternative embodiment adds a GUI reporting capability (319) to generate system usage information. Such information may be useful to both the user (212) and a manager of the invention and would include any type of operational statistics, such as who is using the system, the funds paid and received, the server (210) time being used, the amount of testing of the system, the rules stored in the system, etc.

Consistent with above described preferred embodiment of the system as described in FIG. 2, a method of using that system for document parsing comprises the steps of, providing web browser access to the server (210) over the Internet (211); and enabling user (212) operation of the software (220) using the web browser.

### Example of Software Operable Rules

The following is an example list of classifications, factors and functions of operable software rules that would be created by a structured analysis of the text document according to the invention.

A single document is logically divided as Sections or “Intelli-Zones.” These Zones can also have sub-zones. The final desired output of extracted information is classified as an “Element;” Element can be defined as a block of text in a Zone. An Element can exist at the top-level Zone or can be part of a sub-zone. More than one element can exists in a Zone. A “rule” is essentially a definition to identify a Zone or to extract an “element” from the document. These rules may or may not have run-time validation that will enforce functional requirements for Zones & Elements. The software then implements summary level validation on the Elements within a Zone.

Document Definition: High-level document properties can be defined in these screens. Page-breaks; Variable declaration for processing; Document level validations; Pre-processing routines; Post-processing routines; Logging destinations; and Notification Options.

Zone Definition: Screen for defining start of a zone in the document. Following options are available: Name & Descriptions; Output name selections; Zone Start pattern is specified; Zone Start is case sensitive or case insensitive; Zone Start is a case sensitive word; Zone Start is validated with a set of “Excluded Patterns;” Similarly, Zone End can be configured the same way; Zone End is case sensitive or case insensitive; Zone End can also be a case sensitive word; Zone End can also be checked not to contain one of “Excluded Patterns;” Zone can also be added with additional properties like Start & End Offsets; Offset value overrides the actual start/end position by that many number of lines forward or backwards; Offset is specified towards Start or End definition; Zone can also have Header/Footer block defined; Header block can be defined in terms of the total lines to be ignored after the page-break during the document processing; Repetitive Options—Repeats more than once; Custom variable declarations at the Zone level.

Zone Validations: Zone level validations are created to enforce functional/business requirements. These are: Summary level elements can be validated to match detail elements; Variables declared at Document or Zone level can be checked for a specific condition; Standard processing checks;

Element Definition: Name and Descriptions; Output name definitions; Custom element declarations; Assignment of standard pseudo values available during processing time; Assignment of a hardcoded value that can be referenced later from by a Zone/Element. Making an Element Inactive; Choosing Parent mappings for Custom elements; Selection of standard functions that should be applied on custom elements; Line start pattern is specified; Line start is case sensitive; Line search pattern is specified; Line search pattern is case sensitive; If the pattern matches, the line is considered for subsequent processing; Element search pattern is specified; Element search pattern is case sensitive; Element can be checked to contain a set of “Included Patterns”; Element can be checked not to contain a set of “Excluded Patterns”. Following Pickup definitions can be applied. Full line option; Range Option by specifying Start & End patterns; Vertical Block with the options of Current Block or Reference blocks; Vertical Blocks option can also define Offsets that will move line numbers before or after; Vertical Blocks can also be specified with Delimiter character that will act as a block separator; Vertical Blocks can also be defined to pickup text from left to right or right to left; Number of consecutive blocks can be specified; Horizontal Blocks can be specified as a range pickup with start & end patterns or a position pickup with a start & end position; Block concatenation character can be selected to wrap the retrieved text; Horizontal block definition can also contain the limit for the number of blocks; Horizontal block can also contain “Exit” condition when encounters a Blank character or reached a maximum block number or encountered a specific pattern.

Element Formatting: Element Formatting; Captured element is formatted with: Left padding with selected pattern; Right padding with selected pattern; Left/Right padding can be restricted with maximum length; Replace special characters; Replace Custom characters from the extracted text; Removing additional space by selecting Trim option; Extracting a portion of the text by specifying Start & End position; Converting the extracted value to a lookup value by matching to a Value/Pair set.

Element Validation: Wide range of validations can be performed on these data elements. Exception is raised as Error, Warning, Information or Debug; Mandatory/Option check is performed; Data type validation is performed; Special character validation is performed; Length validation is performed; Look-up validation is performed for a match; Look-up validation is performed for a non-match; Less than validation is performed for numeric data type elements by comparing it to a hard-coded value or against a custom element; Greater than validation is performed for numeric data type elements by comparing it to a hard-coded value or against a custom element; and, Range validation is performed for numeric data type elements by comparing it to a hard-coded value or against a custom element.

Scheduling: Application allows scheduling extraction routines to run at a regular interval. Functionalities are: Choosing the format; Assigning to a designated folder location or a remote server location; Specifying the job timing either to be Timely (in every ‘x’ minutes or in every ‘y’ hours) or Daily or Weekly or Monthly or Yearly or One-time; Choosing the desired output formats; and Error handling actions; Choosing Notification options.

The software is designed to interact with external computers using remote web service. Web Service is a software system designed to support interoperable Machine to Machine interaction over a network using SOAP (Simple Object Access Protocol) standard. Web services are frequently just Web APIs that can be accessed over a network, such as the Internet. The software can be configured to extract text document that are stored in a remote computer using web service as long as the remote computer is enabled to handle the communication. This option can be chosen as an option to automate the document parsing when defining the source location. The software can also be configured to process the output (extracted data) on to a remote computer through web service access as long as the remote computer is enabled to handle the communication. In either case, during setup the user is required to specify all the details such as remote server IP addresses web URLs (Uniform Resource Locator) for the web service as well as access details.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A method in which a user can parse a document comprising the steps of:
(a) presenting to the user a graphical user interface to interact with a server over the Internet using a web browser;
(b) receiving from a user an electronic document in text format, said electronic document being received over the Internet at the server;
(c) enabling the user to specify rules computer implementable to extract textual information from the electronic document;
(d) implementing the rules to extract the textual information;
(e) storing the extracted textual information in an electronic format;
(f) accepting payment from the user for delivery of extracted textual information; and,
(g) delivering the extracted textual information to the user.

2. The method of claim 1 further comprising the step of storing the rules for future user specification.

3. The method of claim 1 wherein the rules are further computer implementable to alter the extracted textual information as defined by the user.

4. The method of claim 1 wherein the rules are further computer implementable to call and implement an external program to alter the extracted textual information from the text document.

5. The method of claim 1 further comprising the steps of enabling the user to specify validation criteria to assess the acceptability of the extracted textual information; and, validating the extracted textual information.

6. The method of claim 1 further comprising the step of enabling the user to select a method to deliver the extracted textual information to the user, said method selected a group consisting of email to the user, user-initiated download from the server using the web browser, delivery of a paper printout, delivery of a portable storage device containing the information, transmission to a user-designated database, and providing accessibility through remote web service invocation.

7. A system for parsing a document comprising:
(a) a server accessible via the Internet using a web browser; and,
(b) software, accessible by a user connecting with the server over the Internet through the web browser, operable to
present to the user a graphical user interface to interact with the server to
receive from a user an electronic document in text format,
create rules implementable to extract textual information from the electronic document,
implement the rules to extract the textual information,
accept payment from the user for delivery of extracted textual information, and,
deliver the extracted textual information to the user; and,
store the extracted textual information in an electronic format.

8. The system of claim 7 wherein the software is further operable to present to the user a graphical user interface to interact with the server to receive registration information from the user.

9. The system of claim 7 wherein the software is further operable to present to the user a graphical user interface to interact with the server to receive from the user login information, perform validation of such user information, recognize the user and assign permission use the system.

10. The system of claim 7 wherein the software is further operable to test, alter and validate the rules to extract the textual information.

11. The system of claim 7 wherein the software is further operable to present to the user a graphical user interface to interact with the server to schedule implementation of the rules to extract the textual information at a specified time.

12. The system of claim 7 wherein the software is further operable to present to the user a graphical user interface to interact with the server to permit a user to view the extracted textual information prior to accepting payment from the user.

13. The system of claim 7 wherein the software is further operable to present to the user a graphical user interface to interact with the server to permit a user to choose a delivery method for extracted textual information.

14. The system of claim 7 wherein the software is further operable to store a rule on the server and to present to the user a graphical user interface to interact with the server to perform a search of stored rules to offer to the user a best-matched rule for the electronic document received from the user.

15. The system of claim 14 wherein the software is further operable to present to the user a graphical user interface to interact with the server to copy and alter a stored rule.

16. The system of claim 7 wherein the software is further operable to present to the user a graphical user interface to interact with the server to receive a sample file from the user for testing to explore system functionality.

17. The system of claim 7 wherein the software is further operable to enforce a usage limitation on a user account.

18. The system of claim 7 wherein the software is further operable to present to the user a graphical user interface to interact with the server to permit a user to automate periodic transfer of an electronic document in text format from a user's computer system.

19. The system of claim 7 wherein the software is further operable to generate system usage information.

20. A method of using the system of claim 7 for document parsing comprising the steps of,
(a) providing web browser access to the server over the Internet; and,
(b) enabling user operation of the software using the web browser.
